(19) United States
(12) Patent Application Publication
(10) Pub. No.: US 2021/0329219 A1
(43) Pub. Date: Oct. 21, 2021

(54) TRANSFER OF ADDITIONAL INFORMATION AMONG CAMERA SYSTEMS

(71) Applicant: Robert Bosch GmbH, Stuttgart (DE)

(72) Inventors: Dirk Raproeger, Wunstorf (DE); Lidia Rosario Torres Lopez, Hildesheim (DE); Paul Robert Herzog, Hildesheim (DE); Paul-Sebastian Lauer, Hannover (DE); Uwe Brosch, Algermissen (DE)

(21) Appl. No.: 17/271,046

(22) PCT Filed: Oct. 29, 2019
(86) PCT No.: PCT/EP2019/079535

§ 371 Date: Feb. 24, 2021

(30) Foreign Application Priority Data
Dec. 13, 2018 (DE) 10 2018 221 625.8

(51) Int. Cl. H04N 13/275; B60R 1/00; G06N 3/08; G06K 9/62; G06T 7/70; H04N 13/239

(52) U.S. Cl. CPC H04N 13/275; B60R 1/00; G06N 3/08; B60R 2300/304; G06T 7/70; H04N 13/239; B60R 2300/107; G06K 9/6267

(57) ABSTRACT

A method for enriching a target image, which a target camera system had recorded of a scene, with additional information, with which at least one source image that a source camera system had recorded of the same scene from a different perspective, has already been enriched. The method includes: assigning 3D locations in the three-dimensional space, which correspond to the positions of the source pixels in the source image, to source pixels of the source image; assigning additional information which is assigned to source pixels, to the respective, associated 3D locations; assigning those target pixels of the target image, whose positions in the target image correspond to the 3D locations, to the 3D locations; assigning additional information, which is assigned to 3D locations, to associated target pixels. A method for training a Kl module is also described.

### FIELD

The present invention relates to a method for processing images recorded by different camera systems. The method can be used, in particular for driver assistance systems and systems for at least partially automated driving.

### BACKGROUND INFORMATION

Images of the driving environment recorded by camera systems constitute the most important source of information for driver assistance systems and for systems for at least partially automated driving. Often, the images include additional information, such as a semantic segmentation obtained using an artificial neural network. The additional information is linked to the camera system used in each case.

U.S. Pat. No. 8,958,630 B1 describes a method for manufacturing a classifier for the semantic classification of image pixels which belong to different object types. In the process, the database of the learning data is enlarged in an unsupervised learning process.

U.S. Pat. Nos. 9,414,048 B2 and 8,330,801 B2 describe methods which can be used to convert two-dimensional images and video sequences into three-dimensional images.

### SUMMARY

In accordance with an example embodiment of the present invention, a method for enriching a target image that a target camera system recorded of a scene, is provided to include additional information. The additional information is assigned to a source image of the same scene recorded by a source camera system from a different perspective, respectively to source pixels of this source image. In other words, the source image is already enriched with this additional information.

The additional information may be of any type. For example, it may include physical measurement data that had been collected in connection with the recording of the source image. The source camera system may be a camera system, for example, which includes a source camera that is sensitive to visible light and a thermal imaging camera that is oriented toward the same observation area. This source camera system may then record a source image using visible light, and an intensity value from the simultaneously recorded thermal image is then assigned as additional information to each pixel of the source image.

3D locations in the three-dimensional space, which correspond to the positions of the source pixels in the source image, are assigned to the source pixels of the source image. Thus, a three-dimensional representation of the scene is determined which leads to the input source image, when imaged by the source camera system. It is not necessary that this representation be continuous and/or complete in the three-dimensional space in the manner of a conventional three-dimensional scene, especially because it is not possible for a specific three-dimensional scene to be uniquely inferred from a single two-dimensional image. Rather, there are a plurality of three-dimensional scenes that produce the same two-dimensional source image when imaged using the source camera system. Thus, the three-dimensional representation obtained from a single source image may be a point cloud in the three-dimensional space, for example, in which there are exactly the same number of points as the source image has source pixels and in which, in other respects, the three-dimensional space is assumed to be empty. Thus, when these points are applied in a three-dimensional representation, the three-dimensional volume is sparsely occupied.

Additional information, which is assigned to source pixels, is assigned to the respective, associated 3D locations. Thus, in the aforementioned example of the additional thermal imaging camera, the intensity value of the thermal image associated with the corresponding pixel in the source image is assigned to each point in the three-dimensional point cloud, which corresponds to the source image.

At this stage, those target pixels of the target image, whose positions in the target image correspond to the 3D locations, are assigned to the 3D locations. Thus, a determination is made as to which target pixels in the target image the 3D locations are imaged onto when the three-dimensional scene is recorded by the target camera system. This assignment is derived from the interplay of the placement of the target camera system in the space and the imaging properties of the target camera system.

The additional information, which is assigned to the 3D locations, is assigned at this stage to the associated target pixels.

In this manner, the additional information, which was originally developed in connection with the source image, is transferred to the target image. It is thus possible to provide the target image with this additional information without having to physically re-record the additional information.

The basic idea underlying the example method is that the additional information, as the infrared intensity from the thermal image in the mentioned example, is not primarily physically linked to the source pixel of the source image, rather to the associated 3D location in the three-dimensional space. In this example, matter, which emits infrared radiation, is located at this 3D location. In each particular case, this 3D location is imaged onto different positions only in the source image and in the target image since the source camera and the target camera view the 3D location from different perspectives. The method takes advantage of this relationship by reconstructing 3D locations in a three-dimensional “world coordinate system” into source pixels of the source image and subsequently assigning these 3D locations to target pixels of the target image.

An especially advantageous embodiment of the present invention provides that a semantic classification of image pixels be selected as additional information. Such a semantic classification may, for example, assign the information about the type of object, to which the pixel belongs, to each pixel. The object may be a vehicle, a lane, a lane marking, a lane barrier, a structural obstacle or a traffic sign, for example. The semantic classification is often performed by neural networks or other K1 modules. These K1 modules are trained by inputting a plurality of learning images thereinto, for each of which the correct semantic classification is known as “ground truth.” It is checked to what extent the classification output by the K1 module corresponds to the “ground truth” and, from the deviations, it is learned by the processing of the K1 module being optimized accordingly.

The “ground truth” is typically obtained by semantically classifying a plurality of images of people. This means that, in the images, the person marks which pixels belong to objects of which classes. This process termed “labelling” is time-consuming and expensive. In conventional approaches, the additional information updated in this manner by people was always linked to exactly that camera system used to record the learning images. If the switch was made to a different type of camera system, for instance, from a normal perspective camera to a fish-eye camera, or even if only the perspective of the existing camera system was changed, the “labeling” process would have to completely start from the beginning. Since it is now possible to transfer the semantic classification, which already exists for the source images recorded by the source camera system, to the target images recorded by the target camera system, the work previously invested in connection with the source images may be used further.

This may be especially important in connection with applications in motor vehicles. In driver assistance systems and systems for at least partially automated driving, an ever increasing number of cameras and an ever increasing number of different camera perspectives are being used.

Thus, it is common, for example, to install a front camera in the middle, behind the windshield. For this camera perspective, there is a considerable amount of “ground truth,” which is in the form of images that are semantically classified by people and is still currently being produced. Moreover, systems are being increasingly developed, however, that include other cameras in addition to the front camera system, for instance, in the front-end section in the radiator section, in the side-view mirror or in the tailgate. At this stage, the neural network, which was trained using recordings of the front camera and associated “ground truth,” provides a semantic classification of the view from the other cameras from the other perspectives thereof. This semantic classification may be used as “ground truth” for training a neural network using recordings from these other cameras. The “ground truth” acquired in connection with the front camera as a source camera may thus be used further for training the other cameras as target cameras. Thus, “ground truth” merely needs to be acquired once for training a plurality of cameras, i.e., the degree of complexity for acquiring “ground truth” is not multiplied by the number of cameras and perspectives.

The source pixels may be assigned to 3D locations in any desired manner. For example, for at least one source pixel, the associated 3D location may be determined from a time program in accordance with which at least one source camera of the source camera system moves in the space. For example, a “structure from motion” algorithm may be used to convert the time program of the motion of a single source camera into an assignment of the source pixels to 3D locations.

In an especially advantageous embodiment of the present invention, a source camera system having at least two source cameras is selected. On the one hand, the 3D locations associated with source pixels may then be determined by stereoscopic evaluation of source images recorded by both 3D cameras. The at least two source cameras may be included, in particular in a stereo camera system which directly provides depth information for each pixel. This depth information may be used to assign the source pixels of the source image directly to 3D locations.

On the other hand, source pixels from source images recorded by both source cameras may also be merged in order to assign additional information to more target pixels of the target image. Since the perspectives of the source camera system and of the target camera system are different, the two camera systems do not exactly reproduce the same section of the three-dimensional scene. Thus, when the additional information is transferred from all source pixels of a single source image to target pixels of the target image, not all target pixels of the target image are covered by the same. Thus, there will be target pixels to which no additional information has yet been assigned. Gaps in this regard in the target image may then be filled by using a plurality of source cameras, preferably two or three. However, this is not absolutely necessary for the training of a neural network or other K1 module on the basis of the target image. In particular, in the case of such a training, target pixels of the target image, for which there is no additional information, may be excluded from the assessment by the measure of quality (for instance, an error function) used in the training.

To obtain the 3D structure observed both by the source camera system and the target camera system in accordance with another embodiment of the system, any 3D sensor at all may provide a point cloud, which uses a suitable calibration method to locate both the source pixels and the target pixels in the 3D space and consequently ensure the transferability of the training information from the source system to the target system.

Other possible 3D sensors, which, for the training, merely determine the connecting 3D structure of the observed scene, could be an additional imaging time-of-flight (TOF) sensor or a lidar sensor, for instance.

Another advantageous embodiment of the present invention provides that a source image and a target image be selected that have been recorded simultaneously. This ensures that, apart from the different camera perspectives, an image of the same state of the scene is formed by the source image and the target image, especially in the case of a dynamic scene that includes moving objects. On the other hand, if there is a time offset between the source image and the target image, an object which was still present in the one image may possibly have already disappeared from the detection region by the time the other image is recorded.

An especially advantageous embodiment of the present invention provides that a source camera system and a target camera system be selected that are mounted on one and the same vehicle in a fixed orientation relative to each other. The observed scenes are typically dynamic, especially in the case of applications in and on vehicles. If the two camera systems are mounted in a fixed orientation relative to each other, a simultaneous image recording is possible, in particular. The fixed connection of the two camera systems has the effect that the difference in perspectives between the two camera systems remains constant during the drive.

As explained above, the transfer of additional information from a source image to a target image is beneficial regardless of the specific nature of the additional information. However, an important application is the further use of “ground truth,” which had been generated for the processing of images of a camera system having a K1 module, for processing images of another camera system.

For that reason, the present invention also relates to a method for training a K1 module, which assigns additional information to an image recorded by a camera system and/or to pixels of such an image through processing in an internal processing chain. Specifically, this additional information may be a classification of image pixels. In particular, the internal processing chain of the K1 module may contain an artificial neural network (ANN).

The performance of the internal processing chain is defined by parameters. These parameters are optimized during training of the K1 module. In the case of an ANN, the parameters may be weights, for example, which are used for weighting the inputs received by a neuron in relation to each other.

During training, learning images are input into the K1 module. The additional information output by the K1 module is compared to additional learning information associated with the respective learning image. The result of the comparison is used to adapt the parameters. For example, an error function (loss function) may depend on the deviation ascertained in the comparison, and the parameters may be optimized with the aim of minimizing this error function. Any multivariate optimization method, such as a gradient descent method, for example, may be used for this purpose.

Using the above-described method, the additional learning information is at least partially assigned to the pixels of the learning image as target pixels. This means that additional learning information is used further that was created for another camera system and/or for a camera system, which is observing from a different perspective. The generation of “ground truth” for the specific camera system, which is to be used in connection with the trained K1 module, may thus be at least partially automated. The development costs for combinations of K1 modules and new camera systems are thus significantly reduced since manually generating “ground truth” was very labor-intensive. In addition, the susceptibility to errors is also reduced since, once checked, “ground truth” may be further used many times.

The methods may be implemented, in particular on a computer and/or on a control unit and, in this respect, be embodied in a software. This software is a stand-alone product having benefits to the customer. For that reason, the present invention also relates to a computer program having machine-readable instructions, which, when executed on a computer and/or a control unit, cause the computer and/or the control unit to execute one of the described methods.

With reference to the figures, other refinements of the present invention are explained in greater detail below, along with the description of preferred exemplary embodiments of the present invention.

### BRIEF DESCRIPTION OF THE DRAWINGS

FIG. 1 shows an exemplary embodiment of method 100, in accordance with the present invention.

FIG. 2 shows an exemplary source image 21.

FIG. 3 shows an exemplary transformation of source image 21 into a point cloud in the three-dimensional space.

FIG. 4 shows an exemplary target image 31 including additional information 4, 41, 42 transferred from source image 21, in accordance with an example embodiment of the present invention.

FIG. 5 shows an exemplary configuration of a source camera system 2 and of a target camera system 3 on a vehicle 6, in accordance with an example embodiment of the present invention.

FIG. 6 shows an exemplary embodiment of method 200, in accordance with the present invention.

### DETAILED DESCRIPTION OF EXAMPLE EMBODIMENTS

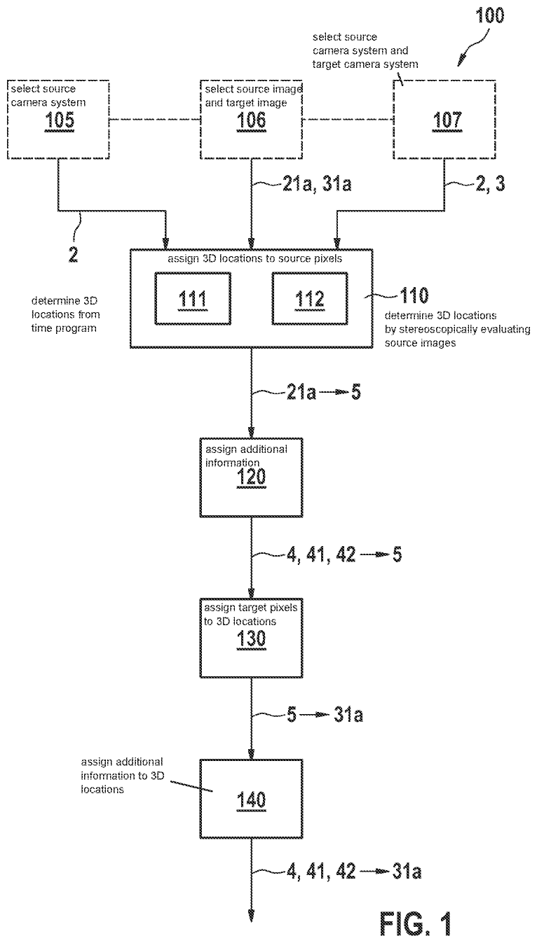

In accordance with FIG. 1, 3D locations 5 in the three-dimensional space are assigned in step 110 of method 100 to source pixels 21a of a source image 21. In accordance with block 111, 3D location 5 associated with at least one source pixel 21a may be determined from a time program in accordance with which at least one source camera of source camera system 2 moves in the space. In accordance with block 112 and alternatively or also in combination therewith, associated 3D location 5 may be determined for at least one source pixel 21a by stereoscopically evaluating source images 21 recorded by two source cameras.

The latter option presupposes that a source camera system having at least two source cameras was selected in step 105. Moreover, in accordance with optional step 106, a source image 21a and a target image 31a may be selected that have been recorded simultaneously. Furthermore, in accordance with optional step 107, a source camera system 2 and a target camera system 3 may be selected, which are mounted on one and the same vehicle 6 in a fixed orientation 61 relative to each other.

In step 120, additional information 4, 41, 42, which is assigned to source pixels 21a of source image 21, is assigned to respective, associated 3D locations 5. In step 130, those target pixels 31a of target image 31, whose positions in target image 31 correspond to 3D locations 5, are assigned to the 3D locations. In step 140, additional information 4, 41, 42, which is assigned to 3D locations 5, is assigned to associated target pixels 31a.

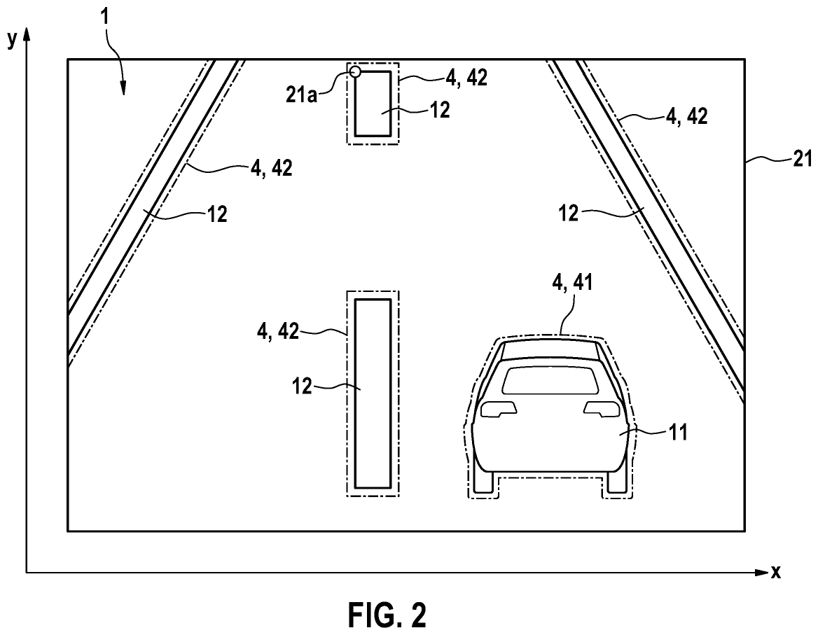

This process is explained in greater detail in FIGS. 2 through 4.

FIG. 2 shows a two-dimensional source image 21 having coordinate directions x and y that a source camera system 2 recorded of a scene 1. Source image 21 was semantically segmented. In the example shown in FIG. 2, additional information 4, 41, that this partial area belongs to a vehicle 11 present in scene 1, has thus been acquired for a partial area of source image 21. Additional information 4, 42, that these partial areas belong to lane markings 12 present in scene 1, has been acquired for other partial areas of source image 21. An individual pixel 21a of source image 21 is marked exemplarily in FIG. 2.

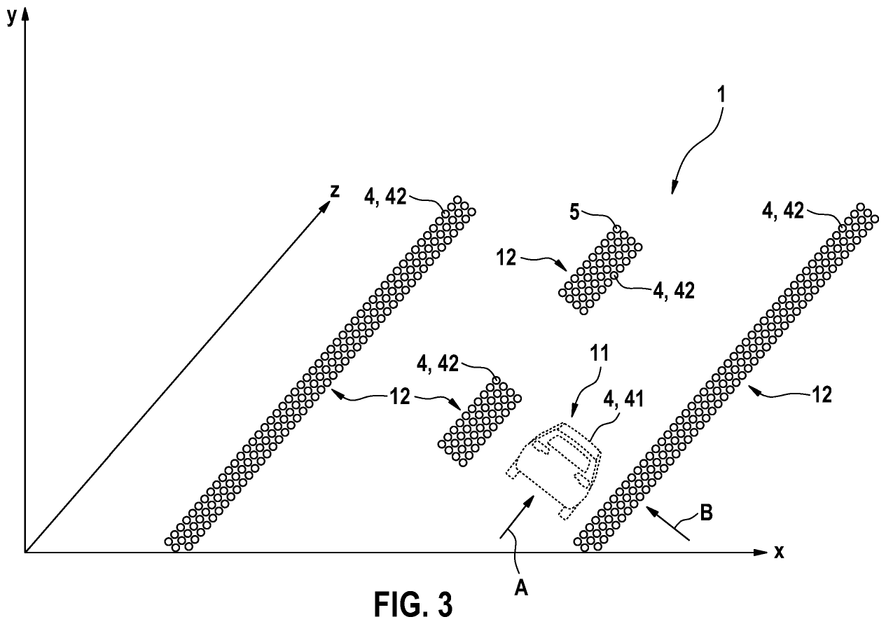

In FIG. 3, source pixels 21a are transformed into 3D locations 5 in the three-dimensional space, this being denoted by reference numeral 5 from FIG. 2 for target pixel 21a. When additional information 4, 41, that source pixel 21a belongs to a vehicle 11, has been stored for source pixel 21a, then this additional information 4, 41 was also assigned to corresponding 3D location 5. When additional information 4, 42, that the source pixel 21a belongs to a lane marking 12, was stored for a source pixel 21a, then this additional information 4, 42 was also assigned to corresponding 3D location 5. This is illustrated by different symbols which represent respective 3D locations 5 in the point cloud shown in FIG. 3.

In FIG. 3, only the same number of 3D locations 5 are entered as there are source pixels 21a in source image 21. For that reason, the three-dimensional space in FIG. 3 is not completely filled, but rather is only sparsely occupied by the point cloud. In particular, only the rear section of vehicle 11 is shown, since only this section is visible in FIG. 2.

Also indicated in FIG. 3 is that source image 21 shown in FIG. 2 was recorded from perspective A. As a purely illustrative example with no claim to real applicability, target image 31 is recorded from perspective B drawn in FIG. 3.

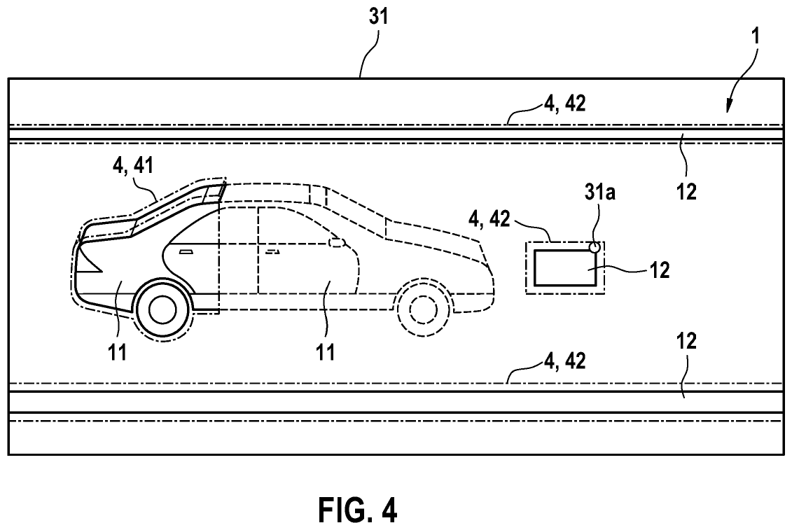

This exemplary target image 31 is shown in FIG. 4. It is marked here exemplarily that source pixel 21a was ultimately circuitously assigned to target pixel 31a via associated 3D location 5. Accordingly, this additional information 4, 41, 42 is circuitously assigned via associated 3D location 5 to all target pixels 31a for which there is an associated source pixel 21a having stored additional information 4, 41, 42 in FIG. 2. Thus, the work invested in this respect in the semantic segmentation of source image 21 is completely reused.

As indicated in FIG. 4, more of vehicle 11 is visible in perspective B shown here than in perspective A of the source image. However, additional information 4, 41, that source pixels 21a belong to vehicle 11, was only recorded with regard to the rear section of vehicle 11 visible in FIG. 2. Thus, the front-end section of vehicle 11, drawn with dashed lines in FIG. 4, is not provided with this additional information 4, 41. This extremely constructed example shows that it is advantageous to combine source images 21 from a plurality of source cameras to provide as many target pixels 31a of target image 31 as possible with additional information 4, 41, 42.

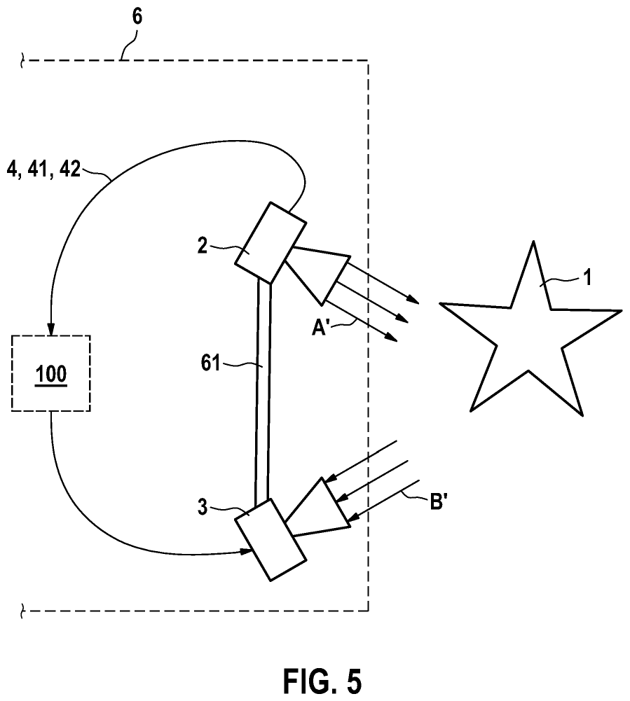

FIG. 5 shows an exemplary configuration of a source camera system 2 and a target camera system 3, which are both mounted on same vehicle 6 in a fixed orientation 61 relative to each other. In the example shown in FIG. 5, a rigid test carrier defines this fixed relative orientation 61.

Source camera system 2 observes scene 1 from a first perspective A′. Target camera system 3 observes same scene 1 from a second perspective B′. Described method 100 makes it possible for additional information 4, 41, 42, acquired in connection with source camera system 2, to be utilized in the context of target camera system 3.

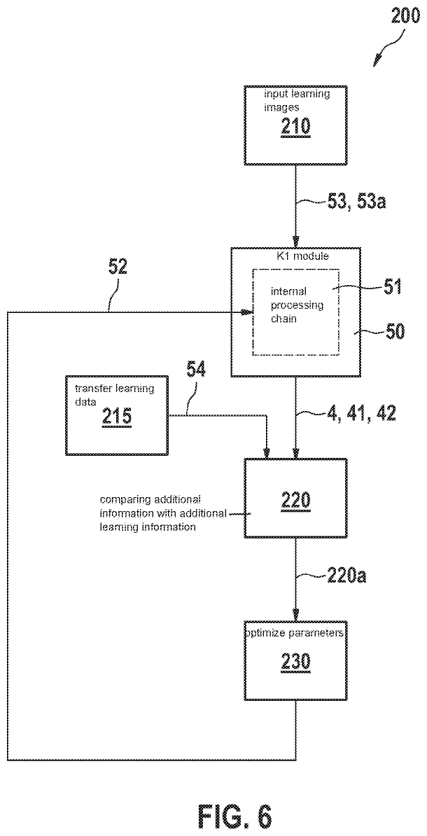

FIG. 6 shows an exemplary embodiment of method 200 for training a K1 module 50. K1 module 50 includes an internal processing chain 51, whose performance is defined by parameters 52.

In step 210 of method 200, learning images 53 having pixels 53a are input into K1 module 50. K1 module 50 provides additional information 4, 41, 42, such as a semantic segmentation, for example, for these learning images. Learning data 54 with regard to which additional information 4, 41, 42 is to be expected in the particular case for an existing learning image 53 is transferred in accordance with step 215 by method 100 into the perspective from which learning image 53 was recorded.

In step 220, additional information 4, 41, 42 actually provided by K1 module 50 is compared with additional learning information 54. Result 220a of this comparison 220 is used in step 230 to optimize parameters 52 of internal processing chain 51 of K1 module 50.

1-10. (canceled)

11. A method for enriching a target image, which a target camera system had recorded of a scene, with additional information, which has already been used to enrich at least one source image that a source camera system had recorded from the same scene from a different perspective, the method comprising the following steps:
assigning 3D locations in a three-dimensional space to source pixels of the source image, which correspond to positions of the source pixels in the source image;
assigning additional information, which is assigned to the source pixels, to the respective, assigned 3D locations;
assigning to the 3D locations those target pixels of the target image, whose positions in the target image correspond to the 3D locations; and
assigning the additional information, which is assigned to the 3D locations, to assigned target pixels.

12. The method as recited in claim 11, wherein, for at least one source pixel, the assigned 3D location is determined from a time program in accordance with which at least one source camera of the source camera system moves in the space.

13. The method as recited in claim 11, wherein the source camera system has at least two source cameras.

14. The method as recited in claim 13, wherein, for at least one source pixel, the assigned 3D location is determined by stereoscopic evaluation of the source images recorded by the two source cameras.

15. The method as recited in claim 13, wherein source pixels from source images (21) recorded by both source cameras are merged in order to assign additional information to more target pixels of the target image.

16. The method as recited in claim 11, wherein the source image and the target image were recorded simultaneously.

17. The method as recited in claim 11, wherein the source camera system and the target camera system are selected which are mounted on the same vehicle in a fixed orientation relative to each other.

18. A method for training a K1 module, which assigns additional information to an image recorded by a camera system and/or to pixels of the image through processing in an internal processing chain, performance of the internal processing chain being defined by parameters, the method comprising the following steps:
inputting a learning image into the K1 module;
comparing additional information output by the K1 module to additional learning information assigned to the learning image; and
using a result of the comparison to adapt the parameters;
wherein the additional learning information is assigned at least partially to pixels of the learning image as target pixels, by:
assigning 3D locations in a three-dimensional space to source pixels of a source image, which correspond to positions of the source pixels in the source image,
assigning additional information, which is assigned to the source pixels, to the respective, assigned 3D locations,
assigning to the 3D locations those target pixels of the learning image, whose positions in the learning image correspond to the 3D locations, and
assigning the additional information, which is assigned to the 3D locations, to assigned the target pixels.

19. The method as recited in claim 10, wherein a semantic classification of image pixels is selected as the additional information.

20. A non-transitory machine-readable storage medium on which is stored a computer program including machine-readable instructions for enriching a target image, which a target camera system had recorded of a scene, with additional information, which has already been used to enrich at least one source image that a source camera system had recorded from the same scene from a different perspective, the machine-readable instructions, when executed by a computer or control unit, causing the computer or the control unit to perform the following steps:
assigning 3D locations in a three-dimensional space to source pixels of the source image, which correspond to positions of the source pixels in the source image;
assigning additional information, which is assigned to the source pixels, to the respective, assigned 3D locations;
assigning to the 3D locations those target pixels of the target image, whose positions in the target image correspond to the 3D locations; and
assigning the additional information, which is assigned to the 3D locations, to assigned target pixels.
